(19) United States
(12) Patent Application Publication
(10) Pub. No.: US 2006/0143888 A1
(43) Pub. Date: Jul. 6, 2006

(54) Machine for rough-machining and planning functional elements of crankshafts or camshafts

(76) Inventor: Alfred Heimmann, Aachen (DE)

Correspondence Address: PROSKAUER ROSE LLP;PATENT DEPARTMENT, 1585 BROADWAY, NEW YORK, NY, 10036-8299, US

(21) Appl. No.: 10/528,876

(22) PCT Filed: Aug. 6, 2003
(86) PCT No.: PCT/EP03/08671

§ 371 Date: Oct. 21, 2005

(30) Foreign Application Priority Data
Sep. 27, 2002 (DE) 102 45 071.4

(51) Int. Cl. B23B 27/00

(52) U.S. Cl. 29/27 C

(57) ABSTRACT

The invention relates to a machine for rough-planing and planning functional elements of crankshafts or camshafts by rotating and/or milling, fitted with two spindle heads which are arranged in the alignment of the axis of rotation of the respectively machined crankshaft of camshaft at a reciprocal distance from each other corresponding to the length of the crankshaft or camshaft and which can be driven at different at different speeds of rotation, respectively provided with a lining and a back center which is integrated into each of the linings. According to the invention, the spindle heads (3 and 4) can be driven directly and are provided with supports (12, 20) which can be displaced in a direction X and Z at a respectively reciprocal distance and which respectively comprise a rotatingly driven milling tool (13), in addition to two supports (15, 21) which are respectively provided with at least one rotating tool (17). The milling and rotating tools are located in diametrically opposite positions in relation to the common axis of rotation of the spindle heads.

The invention relates to machines for rough-planing and planing of functional elements of crankshafts or camshafts by lathing and/or milling with two spindle heads arranged in the alignment of the axis of rotation of the crankshaft or camshaft being machined and at a reciprocal distanced from each other corresponding to the length of the crankshaft or camshaft and which can be driven at different rotational speeds, either being provided with a chuck and with a back center integrated into the chuck. Here the main and connecting rod pins of crankshafts, the bearings and cams of camshafts as well as other parts of crankshafts or camshafts in active connection with other components of a combustion engine for example, are considered to be “functional elements”.

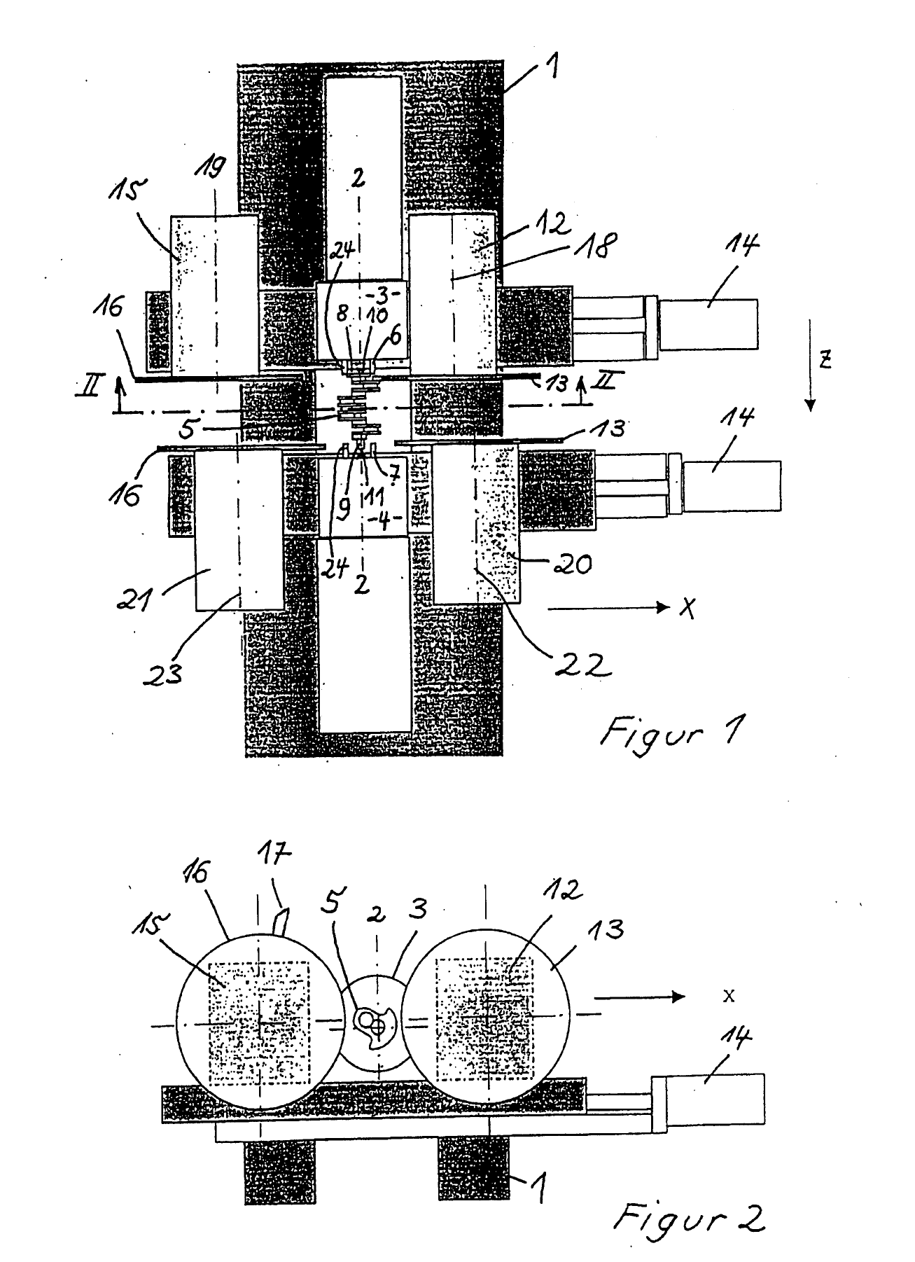

A machine of the type indicated above and used to machine crankshafts is known for example from DE 197 49 939 A1. The known machine
has a spindle head driven at variable rotational speeds, each with a chuck for the camshaft,
a back center integrated into each chuck,
a carriage traveling in directions X and Z with a rotationally driven milling tool and
a carriage traveling in directions X and Z with a lathing tool.
   (see DE 197 49 939 A1, FIG. 1a and 2, column 4, lines 30-47, column 15, lines 29-39 and column 6, lines 1-4 as well as claims 16, 21, 22 and 23)

Direct spindle drives for tools and their advantages, in particular with regard to high dynamic and precision are generally known. To use such drives also for the rotational movement of the work pieces is also familiar to the person schooled in the art. In this connection a direct drive for a work piece to be machined as it rotates on a lathing machine can be found e.g. in DE 101 30 433 A1.

A machining center of this type for crankshafts for crankshafts is known from DE 43 29 610 C2. For the known machining center a driven face plate is provided for the chucking and rotating of a crankshaft among other things at either end on a machine bed and also has
a universal milling unit traveling in X and Z direction and
a machining head traveling in X and Z direction.

In addition, a so-called “multi-purpose machine” is known from DE 100 52 443 A1. On the multi-purpose machine it should be possible to machine crankshafts on the pin bearing points, main bearing points lateral surfaces, end pins and end flanges on one single machine at low cost and in the shortest possible machining time. At the same time rotationally symmetrical centered surfaces, e.g. those of the main bearing points are to be machined by work piece-based processes, i.e. at high rotational speeds. In machining eccentric rotationally symmetrically surfaces, e.g. pin bearing locations, machining is provided by tool-0based processes, i.e. with low rotational speeds. With work piece based processes, the desired cutting speed is achieved by the rotational speed of the crankshaft. In this connection longitudinal turning, facing, broaching, turn broaching and turn-turn broaching are mentioned. In the tool-based processes the cutting speed is achieved by the movement, in particular the rotation of the tool. In this connection orthogonal milling, outside milling and outside cylindrical grinding are known. Based on these indications, the known combinational machine provides two work piece spindles across from each other at a distance corresponding to the length of the crankshaft and aligned with each other in the main axis of rotation of the crankshaft. While one spindle is able to drive the work piece at high rotational speed, the second spindle is provided to drive the work piece at a rotational speed that is lower by a factor 10. High rotational speeds are used e.g. for turning or broaching main bearing locations of the crankshaft, while low rotational speeds are used to mill or ground. In the known combinational machine the utilization of an equalizing chuck is already provided for. This is a chuck with equalizing clamping jaws. On the known combinational machine it should be possible to machine crankshafts at the required machining points (pin bearing points, main bearing points, lateral clamping jaw surfaces, end pins/end flange) on one single machine and thereby with little expense for investment goods but nevertheless with great time efficiency (see DE 100 52 443 A1, column 3, No. 00131, technical task)

It was found that satisfactory machining results and times can also be achieved on a crankshaft or cam shaft if the complete machining of the crankshaft or camshaft is not carried out on one single machine.

From this derives the object of the present invention to increase manufacturing precision further and in particular to produce functional elements of crankshafts or cam shafts in such manner that they meet with the greatest precision the requirements imposed on them by the movements carried out in operation. In particular, the pins of crankshafts and the cams of camshafts should be made in such manner that they may carry out with great precision the lifting movements required of them in operation. Thus for example, the lifting precision is the condition for the utilization of tangential radii on connecting rod pins, and of course also to reduce the material to be removed by subsequent grinding from the bearing points of the crankshaft.

To attain this objective a machine is proposed in which in addition to the known characteristics of the machine described initially, the spindle heads are designed so that they can be driven directly, each being provided at a respective distance in Z direction with two carriages traveling in X and Z direction, each with a rotatably driven milling tool, as well as with two carriages traveling in X and Z direction, each provided with at least one lathing tool, whereby the milling and lathing tools are diametrically across from each other in relation to the common axis of rotation of the spindle heads.

According to the invention the precise preparation of the crankshaft or camshaft to be machined, e.g. the machining of the main and connecting bearing pins of a crankshaft, is achieved according to the invention by the sequence rough planing and planing. The centering and machining of the ends as well as the drilling of oil bores, fixed rollers (laser hardness), planing, super-finishing of the functional elements of the machined shaft can follow in additional machines.

The first machine provided according to the invention is based on the idea of a short process chain in which the entire production line need not be stopped in case of stoppage or failure of one such machine, but where the capacity of the production line is merely reduced for the time of stoppage. On a first machine of this type a crankshaft or cam shaft can be machined so precisely that the remaining error in main bearing alignment for the subsequent dressing roller is very small.

Instead of a milling tool, the carriage traveling in X and Z direction can also be equi9pped with broaching or grinding tools. Instead of a single lathing tool, a plurality of lathing tools can be installed on the circumference of a revolving disk.

The work piece spindles are to be provided in particular with direct drives. These are drives capable of driving the work piece spindle without interposition of other gears. Such a direct drive is characterized by especially great precision because errors that may occur due to gear play are eliminated. A direct drive has furthermore the advantage that it covers a wide range of rotational speeds and can be controlled with great precision over a wide range of rotational speeds.

Thanks to the utilization of two direct drives aligned with the axis of rotation of the shaft being machined and located at a distance from each other corresponding to the length of that shaft to drive the chucks of the shaft in question, the high rotational torque required for chipping can be introduced into the work piece from two sides at the same time. As a result the torsion of the work piece is considerably reduced.

When using one single work piece spindle, a tail stock with a spindle sleeve is provided across from it, wherein a back center supported in the axis of rotation of the machined shaft can be displaced in axial direction.

When using equalizing chucks it has been shown to be advantageous to provide even two back centers between which the shaft to be machine is received. The adjoining jaw chucks must then only supply torque and this can be done so gently that increased pressure from individual jaws of a chuck is avoided. From this point of view too, the shafts are subjected to less stress thanks to chucking in the work piece spindles, and this finally favors the precision of manufacture.

The direct drives of the work piece spindles are provided in a range of rotational speeds from 5 min⁻¹ to 1500 min⁻¹, preferably however at 1000 min⁻¹.

The machine has two double carriages. Each double carriage consists of a carriage movable in Z direction and capable of moving parallel to the axis of the work piece spindle and of an X carriage which bridges the shaft to be machined and has a milling structure on one side of the shaft, with a milling disk, and on the other side a turning structure with a lathe. The turning structure can consist off a revolving disk with at least one turning chisel, or of a continuous drive with broaching tool for turn broaching.

To shorten the machining time it is advantageous if a second double carriage of the same type is located across from a double carriage at a distance in Z direction, similarly as is the case with the chucks oaf the work piece spindles. In this manner two bearing points of the main bearings or pin bearing can be machined at the same time from both ends of the crankshaft or camshaft to be machined. In this connection two tool carriages are again provided to which lathes or broaching tools are attached. In the latter case it is assumed that they are able to complete a revolution of limited circumference around their spindle axis. When using lathes, revolving disks are provided which are equipped with different tools coming into engagement one after the other. This arrangement also makes it possible to machine the corresponding main bearing points of the crankshaft or camshaft at the same time from both ends. Thus for example, the main bearings one and five as well as the main bearings two and four are machined simultaneously when machining a crankshaft, while the main bearing three is machined by itself alone at the end because of lack of space. For crankpin the machining sequence is similar. First the two ubzapfen? one and four and then the two crankpins two and three are machined simultaneously.

The invention is described in further detail below through an example of an embodiment.

The figures are not to scale and show:

FIG. 1 shows a top view of the machine and

FIG. 2 shows a transversal section through the machine along line II-II of FIG. 1.

On the machine bed 1 two spindle heads 3 and 4 are installed at a distance and across from each other. The reciprocal distance between the two spindle heads 3 and 4 corresponds to the length of a crankshaft 5 which is clamped between the two spindle heads 3 and 4.

The crankshaft 5 is clamped by means of clamping jaws 6 and 7 of which one 6 is to engage at the flange 8 of the crankshaft 5 and the other 7 at its pin 9. In addition the crankshaft 5 is supported and centered at its two ends 8 and 9 in back centers 10 and 11. The back centers 10 and 11 are aligned with the longitudinal central axis 2 of the machine 1 and are at the same time concentric with the main axis of rotation of the crankshaft 5.

In addition a tool carriage 12 is provided through which a milling tool 13 can be driven rotatably. The tool carriage 12 can travel in the two directions X and Z relative to the machine bed 1. For this a suitable known drive 14 is used.

A second tool carriage 15 is provided across from the longitudinal central axis 2 and approximately at the same distance from it. The tool carriage 15 supports e.g. a revolving disk 16 equipped with different turning tools 17 such as e.g. turning chisels or broaching blades.

The tool carriages 12 and 15 can be displaced by a single drive 14 in direction X and if necessary also in direction Z and thus constitute a double carriage.

The milling tool 13 is supported in the tool carriage 12 so as to rotate around the rotational axis 18 and the revolving disk 16 in tool carriage 15 around rotational axis 19.

Two additional tool carriages are provided on the machine bed 1 at a distance equal to a segment of the length of the crankshaft 5 and, due to their common drive 14, also constitute a double carriage. The carriage 20 is also equipped with a milling disk 13 that is driven around the carriage axis 22. Carriage 21 is equipped on the one hand with a revolving disk 16 that can be swiveled around the rotational axis 23. With the help of the two additional tool carriages 20 and 21 the crankshaft 5 can be machined from both ends 8 and9 simultaneously. Here the turning chisels 17 of the two revolving disks 16 are at first attacking simultaneously at the first and fifth, later at the second and fourth and finally one of the two revolving disks 16 with its turning chisel 17 at the third main bearing of the crankshaft 5 while the crankshaft 5 rotates at high speed. By comparison the two milling disks 13 attack with their blades first at the two pin bearings one and four and then at the two pin bearings two and three simultaneously, while the crankshaft 5 rotates at low speed. In the last mentioned machining state the two milling disks 13 approach each other as much as possible in axial direction, i.e. in direction Z.

The two chucks 6 and 7 are provided with the same equalizing clamping jaws 24 ensuring that no unilateral forces are transmitted to the crankshaft 5 when chucking it. Chucks 6 and 7 having these characteristics are called equalizing chucks. Depending on the chip-removing operation, i.e. following turning or milling, the clamping jaws 24 of the equalizing chucks 6 and/or 7 are loosened briefly. Thereby the tension applied to the crankshaft 5 by chip removal can be reduced briefly.

### LIST OF REFERENCE NUMBERS

1 Machine bed
2 Longitudinal central axis
3 Spindle head
4 Spindle head
5 Crankshaft
6 Chuck
7 Chuck
8 Flange
9 pin
10 Back center
11 Back center
12 Tool carriage
13 Milling tool
14 Carriage drive
15 Second tool carriage
16 Revolving disk
17 Turning tool
18 Rotational axis
19 Rotational axis
20 Carriage
21 Carriage
22 Rotational axis
22 Rotational axis
24 Clamping jaws

1. Machine for rough-planing and planing functional elements of crankshafts or camshafts by turning and/or milling, fitted with two spindle heads which are arranged in the alignment of the axis of rotation of the crankshaft or camshaft being machined and which can be driven at different rotational speeds, each provided with a milling tool and with a back center integrated into each of the chucks,
wherein
the spindle heads can be driven directly and are at a respective distance from each other in direction Z
two carriages capable of traveling in directions X and Z are each equipped with a rotationally driven milling tool as well as
two carriages capable of traveling in directions X and Z are each provided with at least one turning tool, whereby the milling and turning tools are located diametrically across from each other relative to the common axis of rotation of the spindle heads.

2. Machine as in claim 1,
wherein
a plurality of turning tools are installed on a revolving disk.

3. Machine as in claim 1,
wherein
at least one back center is fixed or ovable in direction Z.

4. Machine as in claim 1,
wherein
both spindle heads can be driven directly within a range of rotational speeds between 5 min⁻¹ and 1500 min⁻¹.

5. Machine as in claim 1,
wherein
at least one of the two chucks is designed so as to be equalizing.
